(19) United States
(12) Patent Application Publication
(10) Pub. No.: US 2025/0285046 A1
(43) Pub. Date: Sep. 11, 2025

(54) COMPUTER SYSTEM AND TASK ASSIGNMENT CONTROL METHOD

(71) Applicant: HITACHI, LTD., Tokyo (JP)

(72) Inventors: Jumpei Okoshi, Tokyo (JP); Yuya Isoda, Tokyo (JP); Hiroaki Konoura, Tokyo (JP)

(73) Assignee: HITACHI, LTD., Tokyo (JP)

(21) Appl. No.: 18/971,177

(22) Filed: Dec. 6, 2024

(30) Foreign Application Priority Data
Mar. 7, 2024 (JP) 2024-034917

(51) Int. Cl. G06Q 10/0631

(52) U.S. Cl. CPC G06Q 10/063112

(57) ABSTRACT

A computer system is connected with a plurality of worker systems where workers that execute tasks are operated, and holds worker management information for managing the workers. In the worker management information, data that is constituted of items indicating identification information of the workers and characteristics of the workers is stored. In at least one worker system, a large-scale language model is operated as the worker. The computer system receives a task execution request, generates the task execution information relating to the plurality of tasks that are executed until a desired result is obtained with respect to the respective workers, identifies candidate workers based on the worker management information and the task execution information, and selects the worker to which the task is assigned out of the candidate workers.

### CLAIM OF PRIORITY

The present application claims priority from Japanese patent application JP 2024-034917 filed on Mar. 7, 2024, the content of which is hereby incorporated by reference into this application.

### BACKGROUND OF THE INVENTION

### 1. Field of the Invention

The present invention relates to a technique for assigning a task to a worker such as LLMs or the like.

### 2. Description of the Related Art

As a technique for assigning a task to a worker, there has been known techniques described in JP 2015-162109 A and JP 2018-527634 A.

In JP 2015-162109 A, there is a description that “there exists a task assignment server 10 that assigns new task to an expert in a group of workers capable of processing new tasks via network. The task assignment server 10 includes: a worker DB 24 that stores worker group information including at least information on tasks that respective workers of a group of workers processed in the past; a cluster preparation function unit 14 that classifies the respective workers of the group of workers into any one of the plurality of clusters based on the worker group information; and a processing result analysis function unit 18 that sets the worker that belongs to one of the plurality of clusters as the expert based on a processing result of a test task that forms a part of the new task”.

In JP 2018-527634 A, there is a description that “the provision of an efficient multi-dimensional routing algorithm that takes into a count the determination elements including a skill of an agent, a channel used for a particular communication, preferences of individuals, other communication unique information, a balance between the reception and the transmission of the communication, and relative cost for the agent with respect to the particular communication. However, the determination elements are not limited to the above-mentioned elements”.

### SUMMARY OF THE INVENTION

In recent years, a large-scale language model (LLM) has attracted attention as a worker that executes a task. LLM is a natural language processing model constructed using a large amount of text data, and can perform various language processing tasks. The LLM receives a prompt including the content of a task such as a question written in a natural language, understands the meaning of the content of the task, and generates a text that becomes an answer, and outputs the answer.

The LLM has characteristics unique to the LLM, such as a token length and the presence or non-presence of the use of external data and the like. Further, when the LLM is used, it is often the case that a desired result is not obtained by performing a task once. Accordingly, the task is performed a plurality of times while changing the content of the prompt.

In the prior art, the above-mentioned characteristics of LLM are not taken into account. It is an object of the present invention to provide a technique that decides a worker to which a task is assigned by taking into account of characteristics of an LLM.

A representative example of the invention disclosed in the present application is as follows. That is, the present invention provides a computer system that includes: a processor; a storage device connected to the processor; and a network interface connected to the processor, wherein the computer system is connected to a plurality of worker systems in each of which a worker that executes a task using a computer resource is operated, the computer system holds worker management information for managing the worker, data that is constituted of items indicating identification information of the worker and characteristics of the worker is stored in the worker management information, and in at least one of the worker systems, a large-scale language model that executes a language processing task where a prompt that is a text describing an instruction content is received and by a text that forms a response is operated as the worker, and the processor is configured: to accept a task execution request; to generate, for each of the workers, task execution information relating to a plurality of tasks to be executed until a desired result is obtained; to identify candidate workers based on the worker management information and the task execution information, and to select the worker to which the task is assigned from the candidate workers.

According to the present invention, a worker to which a task is assigned can be determined by taking into account characteristics of an LLM. Problems, configurations, and advantageous effects other than those described above will be clarified by the following description of embodiments.

### BRIEF DESCRIPTION OF DRAWINGS

FIG. 1 is a block diagram illustrating one example of the configuration of a system according to a first embodiment;

FIG. 2 is a block diagram illustrating one example of the hardware configuration of a computer according to the first embodiment;

FIG. 3 is a table illustrating one example of information stored in a worker management DB according to the first embodiment;

FIG. 4 is a table illustrating one example of information stored in the worker management DB according to the first embodiment;

FIG. 5 is a table illustrating one example of information stored in an execution log DB according to the first embodiment;

FIG. 6 is a flowchart describing task assignment processing that task assignment management system according to the first embodiment performs;

FIG. 7 is a view illustrating one example of a user interface that the task assignment management system according to the first embodiment displays;

FIG. 8 is an explanatory view illustrating one example of the data structure of a task profile according to the first embodiment;

FIG. 9 is a flowchart describing one example of worker selection processing that the task assignment management system according to the first embodiment performs;

FIG. 10 is an explanatory view illustrating one example of a task performance profile that the task assignment management system according to the first embodiment generates; and

FIG. 11 is a flowchart illustrating one example of worker selection processing that the task assignment management system according to a second embodiment performs.

### DESCRIPTION OF THE PREFERRED EMBODIMENTS

Hereinafter, embodiments of the present invention will be described with reference to the drawings. However, it is not construed that the present invention is limited to the content described in the embodiments explained hereinafter. Those who are skilled in the art can easily understand that the specific configuration of the present invention can be changed without departing from the gist of the concept of the present invention.

In the configurations of the invention described hereinafter, the same or substantially the same configurations or functions are denoted by the same reference symbols, and the repeated description of these configurations is omitted.

The expression such an “first”, “second”, “third” and the like in the present specification and the like are affixed to distinguish the constitutional elements from each other, and it is not always the case that the numbers and the order are restricted.

### First Embodiment

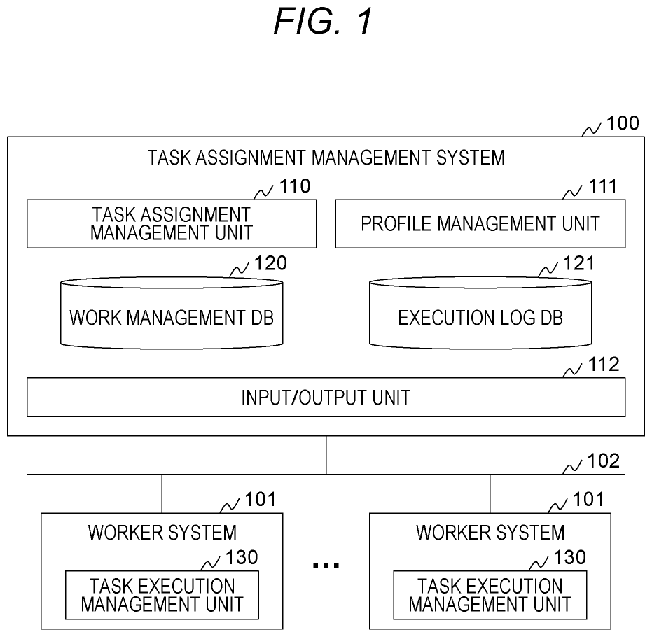

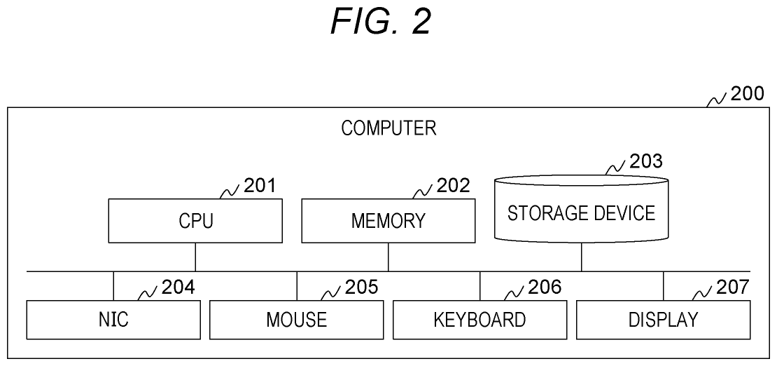

FIG. 1 is a block diagram illustrating one example of the configuration of a system according to a first embodiment. FIG. 2 is a block diagram illustrating one example of the hardware configuration of a computer according to the first embodiment.

A system is constituted of: a task assignment management system 100; and a plurality of worker systems 101. The task assignment management system 100 is connected to a plurality of worker systems 101 via a network 102 such as a local area network (LAN).

The worker system 101 is a system where workers who perform tasks work. The worker system 101 may be an on-premises system or a cloud system. The workers are, for example, tools such as search engines, LLMs, or the like. In this embodiment, the workers include at least one LLM. The worker system 101 has a task performance management unit 130 that manages the performances of the tasks. In the worker system 101, two or more workers may work.

The task assignment management system 100 decides workers to whom the tasks are assigned, or assign tasks to the decided workers. The task assignment management system 100 is, for example, constituted of a computer 200 illustrated in FIG. 2. The computer 200 includes a CPU 201, a memory 202, a storage device 203, an NIC 204, a mouse 205, a keyboard 206, and a display 207.

The functional unit that a task assignment management system 100 includes can be realized when the CPU 201 executes a program loaded in the memory 202. The program and information that the program uses are stored in the storage device 203. The CPU 201 reads the program and information from the storage device 203, and loads the program and the information in the memory 202. the memory 202 includes a work area that the program temporarily uses.

The task assignment management system 100 holds a worker management DB 120 and an execution log DB 121. Task assignment management system 100 also includes a task assignment management unit 110, a profile management unit 111 and input/output unit 112. With respect to the function unit that the task assignment management system 100 includes, a plurality of function units may be integrated into one function unit, or one function unit may be divided into a plurality of function units.

The worker system 101 is constituted of a computer 200 having substantially the same hardware configuration as the task assignment management system 100.

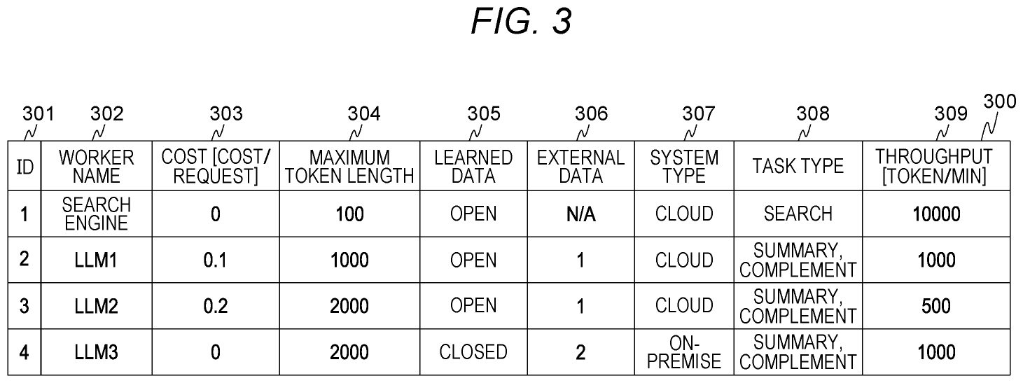

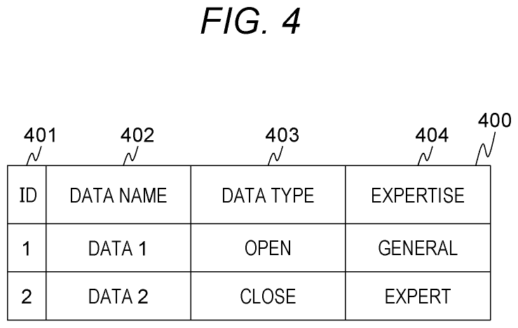

FIG. 3 and FIG. 4 are tables illustrating one example of information stored in the worker management DB 120 of the first embodiment.

The worker management DB 120 stores a table 300 and a table 400. The table 300 is a table for managing the workers. The table 400 is a table for managing characteristics of external data that the worker system 101 uses.

The table 300 stores entries that include an ID 301, a worker name 302, a cost 303, a maximum token length 304, learned data 305, external data 306, a system type 307, a task type 308, and a throughput 309. One entry exists for one worker on a one to one basis. Fields that are included in the entries are not limited to the fields described previously. The entries may not include any one of the above-mentioned fields, or may include other fields.

ID 301 is a field that stores identifiers of the entries. The worker name 302 is a field where the names of the workers are stored.

The cost 303 is a field that stores costs generated due to the performance of the tasks. The maximum token length 304 is a field that stores token lengths that are sizes of data that the workers can process.

The learned data 305 is a field where types of learned data used for generating LLMs or tools are stored. The external data 306 is a field where information on external data that the workers can use are stores. In this embodiment, identifiers (ID 401) of the entries of a table 400 described later are stored.

The system type 307 is a field where types of the worker systems 101 that the workers work are stored. The task type 308 is a field that stores the types of tasks that the workers can perform. The throughput 309 is a field that stores throughputs expressing processing performances of the workers.

The table 400 stores entries including an ID 401, a data name 402, a data type 403 and an expertise 404. One entry exists for one kind of external data on a one to one basis. Fields that are included in the entries are not limited to the fields described previously. The entries may not include any one of the above-mentioned fields, or may include other fields.

The ID 401 is a field that stores identifiers of the entries. The data name 402 is a field where the names of data are stored. The data type 403 is a field where the types of external data are stored. The expertise 404 is a field where presence or non-presence of expertise of external data are stored.

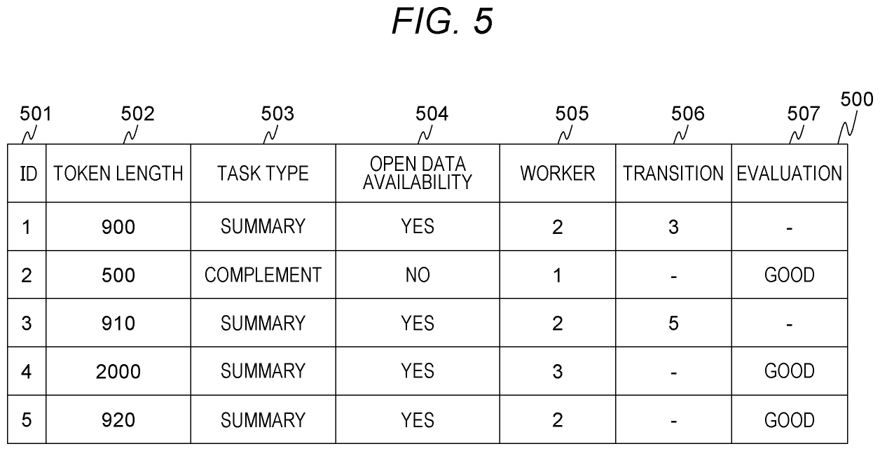

FIG. 5 is a table illustrating one example of information stored in the execution log DB 121 according to the first embodiment.

The execution log DB 121 stores a table 500. The table 500 is a table that stores an execution logs of tasks executed by workers. The table 500 stores entries including an ID 501, a token length 502, a task type 503, an open data availability 504, a worker 505, a transition 506, and an evaluation 507. One entry exists for one task on a one to one basis. Fields that are included in the entries are not limited to the fields described previously. The entries may not include any one of the above-mentioned fields, or may include other fields.

ID 501 is a field that stores identifiers of the entries. The token length 502 is a field for storing token lengths of user requests for instructing execution of tasks. The task type 503 is a field for storing types of tasks. The open data availability 504 is a field for storing information indicating whether or not open data has been available at the time of executing a task. The worker 505 is a field that stores identifiers (ID 301) of workers who have executed tasks. The transition 506 is a field for storing identifiers (ID 501) of tasks to be executed after performing tasks corresponding to the entries.

The evaluation 507 is a field for storing the user evaluations with respect to results of the tasks. When an LLM is used, a task is executed a plurality of times to obtain a desired result. In this case, the evaluation result is stored in the evaluation 507 of the last task, and the evaluation 507 of the intermediate task is held blank. When a desired result is obtained by performing a task only one time, the evaluation result is stored in the evaluation 507 of the task.

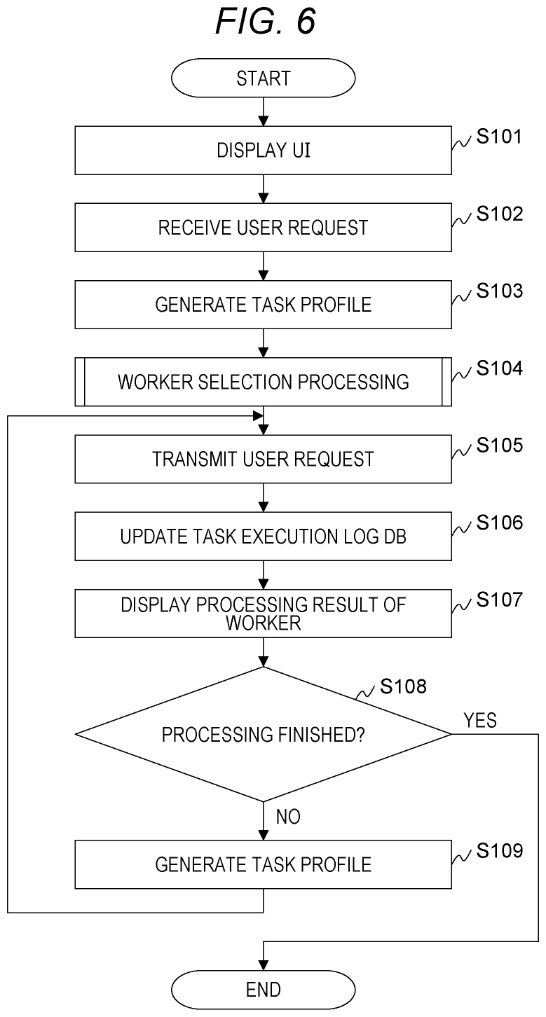

FIG. 6 is a flowchart describing task assignment processing that task assignment management system 100 according to the first embodiment performs.

When the task assignment management system 100 has received an access from a user, the task assignment management system 100 starts task assignment processing described below.

The input/output unit 112 displays a user interface 700 (step S101).

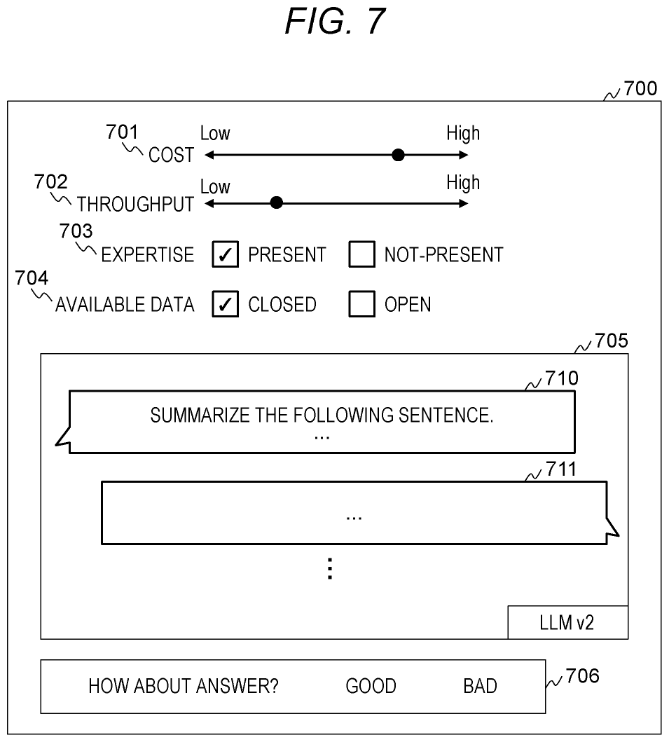

Hereinafter, the user interface 700 is described. FIG. 7 is a screen illustrating one example of the user interface 700 that the task assignment management system 100 according to the first embodiment displays.

The user interface 700 includes setting columns 701, 702, 703, and 704, a chat column 705, and an evaluation column 706.

The setting columns 701, 702, 703, and 704 are columns for setting worker selection conditions. The setting column 701 is a column for setting an upper limit value of a cost. The setting column 702 is a column for setting a lower limit value of a throughput. The setting column 703 is a column where presence or non-presence of expertise of external data is stored. The setting column 704 is a column where a data type of the external data is set.

The chat column 705 is a column where the inputting of a user request that instructs the execution of a task and a result of the execution of the task are displayed. A speech bubble 710 corresponds to a user request. The user request is inputted as a text. A speech bubble 711 corresponds to the result of the execution of the task. An identifier of a worker to which the task is assigned is displayed in the chat column 705. The evaluation column 706 is a column for inputting the user evaluation.

The above describes the user interface 700. The description is made hereinafter by returning to FIG. 6.

The user operates the setting columns 701, 702, 703, and 704, and inputs the first user request in the chat column 705.

When the input/output unit 112 receives the user request for the first time (step S102), the input/output unit 112 calls the task assignment management unit 110. The first user request includes the values set in the setting columns 701, 702, 703, and 704.

The task assignment management unit 110 generates a task profile 800 based on the user request (step S103).

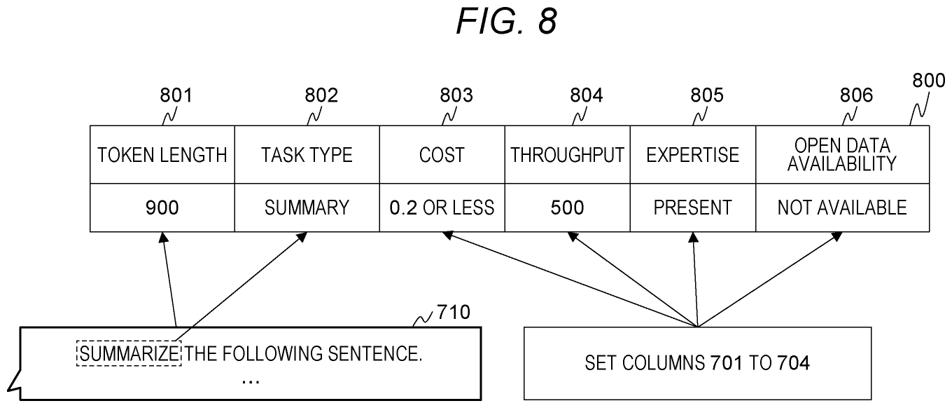

Here, the task profile 800 will be described. FIG. 8 is a view illustrating one example of the data structure of the task profile 800 of the first embodiment. The task profile 800 includes a token length 801, a task type 802, a cost 803, a throughput 804, an expertise 805, and open data availability 806.

The token length 801 stores token lengths in the user request (text). The task type 802 is a field for storing types of tasks. The cost 803 is a field for storing conditions relating to the costs. The throughput 804 is a field that stores conditions relating to the throughputs of the tasks. The expertise 805 and the open data availability 806 are fields for storing conditions relating to external data.

FIG. 8 illustrates an extraction example where the respective values are extracted from the user request. In the token length 801, a token length calculated from a text described in the speech bubble 710 is set. In the task type 802, a task type that is extracted by a text analysis applied to the text described in the speech bubble 710 is set. Values of the setting columns 701, 702, 703, and 704 of the user interface 700 are set in the cost 803, the throughput 804, the expertise 805, and the open data availability 806. The text described in the speech bubble 710 may contain the conditions relating to the cost, the throughput, and the external data. In this case, the task assignment management unit 110 extracts the respective conditions by executing the text analysis.

The task assignment management unit 110 executes a worker selection processing (step S104). The details of the worker selection processing will be described later.

After the worker selection processing is executed, the task assignment management unit 110 transmits a user request to the selected worker (step S105).

The task assignment management unit 110 transmits a user request corresponding to a worker to which a task is assigned. In a case where the worker is an LLM, the task assignment management unit 110 generates a prompt including a type of a task to be executed, the details of the task, information to be referenced, and the like, and transmits the prompt as a user request. In a case where the worker is a tool such as a search engine, the task assignment management unit 110 generates a predetermined query and transmits the query as a user request.

The task assignment management unit 110 updates the execution log DB 121 (step S106). More specifically, the following processing is executed.
(S106-1) The task assignment management unit 110 adds the entries to the execution log DB 121, and sets values to the ID 501, the token length 502, the task type 503, the open data availability 504, and the worker 505. The values contained in the task profile 800 are set in the token length 502, the task type 503, and the open data availability 504. The IDs of the workers selected in the worker selection processing are set with respect to the workers 505.
(S106-2) The task assignment management unit 110 determines whether or not IDs of other tasks are stored in the work area.
(S106-3) When the IDs of other tasks are not recorded in the work area, the task assignment management unit 110 records the IDs of the added entries in the work area, and ends the processing in step S105.
(S106-4) When the IDs of other tasks are recorded in the work area, the task assignment management unit 110 sets the IDs of the entries added to the transition 506 of the entries corresponding to the IDs, records the IDs of the added entries in the work area, and ends the processing in step S105.

When the task assignment management unit 110 acquires the result of the execution of the task from the worker, the task assignment management unit 110 instructs the input/output unit 112 to display the result of the execution of the task. The input/output unit 112 displays the result of the execution of the task on a user interface 700 (step S107).

The input/output unit 112 determines whether or not the processing has ended (step S108). More specifically, the input/output unit 112 determines which one out of the user request and the evaluation result is received by the input/output unit 112 as an input from the user.

In a case where the input/output unit 112 receives the user request, the input/output unit 112 generates the task profile 800 (step S109) and, thereafter, returns to step S105. The user request is transmitted to the worker selected in the worker selection processing.

In a case where the input/output unit 112 receives the evaluation result, the input/output unit 112 determines that the processing is ended, sets the evaluation result in the evaluation 507 of the entry added in step S105, and, thereafter, ends the task assignment processing.

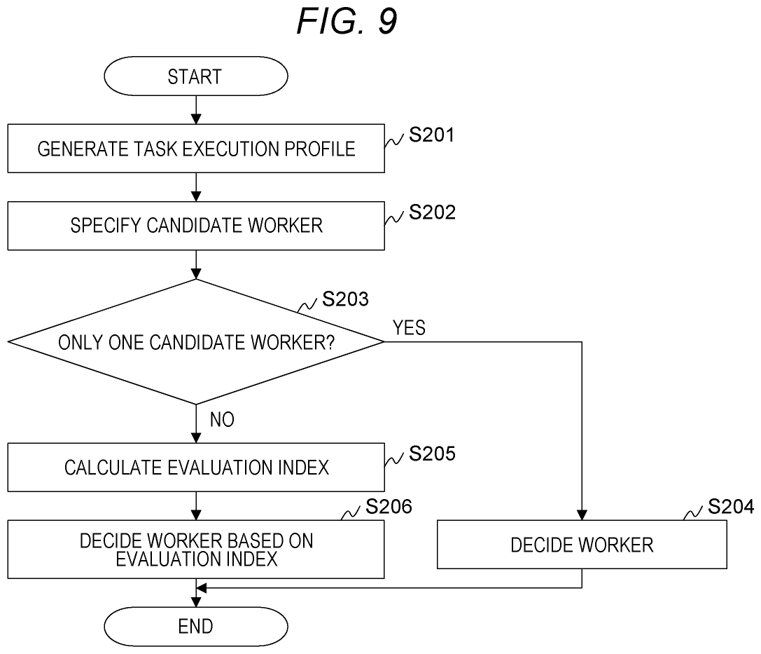

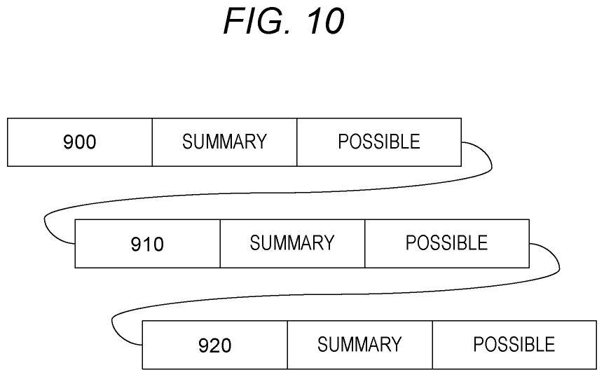

FIG. 9 is a flowchart illustrating an example of worker selection processing executed by the task assignment management system 100 according to the first embodiment. FIG. 10 is a diagram illustrating an example of a task execution profile generated by the task assignment management system 100 according to the first embodiment.

The task assignment management unit 110 generates a task execution profile (step S201). More specifically, the following processing is executed.
(S201-1) The task assignment management unit 110 selects one worker.
(S201-2) The task assignment management unit 110 acquires an execution log of the worker selected from the execution log DB 121.
(S201-3) The task assignment management unit 110 collects the execution logs of the tasks executed until the user evaluation is obtained, and generates a task execution profile.

For example, in a case where “worker 2” is selected, a task execution profile that includes a plurality of execution logs to be executed in order as illustrated in FIG. 10 is generated. In a case where there is a plurality of task groups that are executed until the user evaluation is obtained, the task execution profile includes a plurality of execution log groups corresponding to the task groups.
(S201-4) The task assignment management unit 110 calculates the number of execution logs included in the task execution profile as the number of times of task execution.

For example, in a case where “worker 2” is selected, the task has been executed three times until the user evaluation is obtained, and hence, the number of times of task execution is calculated as “3”. When a plurality of task groups are included in the task execution profile, the task assignment management unit 110 calculates an average value of the numbers of times that the task is executed that are calculated from the respective task groups.
(S201-5) The task assignment management unit 110 stores the workers, the task execution profile, and the numbers of times that the tasks are executed in the work area in an associated manner with each other.
(S201-6) The task assignment management unit 110 determines whether or not processing has been completed with respect to all workers. In a case where the processing has not been completed with respect to all workers, the task assignment management unit 110 returns to S201-1. When the processing is completed with respect to all workers, the task assignment management unit 110 ends the processing in S201.

The task assignment management unit 110 identifies candidate workers to which a task can be assigned based on the task profile 800, the task execution profile, and the worker management DB 120 (step S202). For example, candidate workers are identified from the following viewpoints.

### (1) Security

In a case where the availability of the open data is prohibited, a worker who uses the external data where data type 403 is “closed” is identified. The task assignment management unit 110 references the task execution profile. When the task execution profile includes the execution log of the task that uses external data where the data type is “open”, the task assignment management unit 110 excludes the worker from the selection target.

### (2) Processing Performance

When a throughput is specified, the worker whose throughput is larger than the specified throughput is identified. Further, a worker whose maximum token length 304 is larger than the token length of the user request is identified. The task assignment management unit 110 references the task execution profile. When the task execution profile includes the execution log of the task having the token length larger than the specified token length, the worker is excluded from the section target.

### (3) Expertise

In a case where the expertise of the external data is specified, the worker who uses the external data having specified expertise is identified. The task assignment management unit 110 references the task execution profile. When the task execution profile includes the execution log of the task that does not use the external data having specified expertise, the worker is excluded from the selection target.

The task assignment management unit 110 determines whether or not the number of candidate workers is one (step S203).

In a case where the identified worker is one worker, the task assignment management unit 110 decides the candidate worker as the worker to which the task is assigned (step S204).

In a case where a plurality of candidate workers exist, the task assignment management unit 110 calculates an evaluation index of each candidate worker by referencing the execution log DB 121 (step S205). More specifically, the following processing is executed.
(S205-1) The task assignment management unit 110 references the table 300, and acquires the values of the costs 303 of the entry corresponding to the candidate workers.
(S205-2) The task assignment management unit 110 calculates an evaluation index of the each candidate worker based on the number of times of task execution and the cost of the respective candidate workers. For example, the following calculation method is conceivable.
(Method 1) The task assignment management unit 110 calculates multiplication values of the number of times of task execution and the cost of respective candidate workers as an evaluation index.
(Method 2) The task assignment management unit 110 calculates a first index by multiplying the number of times of task execution and the cost of the respective candidate workers. The task assignment management unit 110 identifies a maximum value of the number of times of task execution of the respective candidate workers based on the processing result of S204, and calculates a second index by dividing the numbers of times of task execution of the respective candidate workers by the maximum value. The task assignment management unit 110 identifies a maximum value of the first index by comparing the first indexes of the respective candidate workers, and calculates a third index by dividing the first indexes of the respective candidate workers by the maximum value. The task assignment management unit 110 calculates the sum of the second index and the third index as an evaluation index.

The evaluation index may be corrected based on the evaluation result of the user. For example, a correction method is considered where an evaluation index of the worker where the ratio of the task group that exhibits evaluation 507 of “good” is 70% or more is multiplied by a coefficient.

The task assignment management unit 110 decides a worker based on the evaluation index (step S206). For example, the task assignment management unit 110 decides a worker having the minimum evaluation index as a worker to which a task is assigned.

According to the first embodiment, the worker to which the task is assigned can be selected by taking into account the characteristics of the LLM. In particular, by using the information (task execution profile) relating to the task group executed using the LLM until the user evaluation is obtained, it is possible to select a worker in consideration of an additional task that is generated when the task is assigned to the worker.

### Second Embodiment

The second embodiment differs from the first embodiment with respect to a method of generating a task execution profile. Hereinafter, the second embodiment will be described by focusing on the difference between the first embodiment and the second embodiment.

The configuration of the system of the second embodiment is the same as the configuration of the first embodiment. The functional configuration of the task assignment management system 100 of the second embodiment is the same as the functional configuration of the first embodiment. The task assignment processing of the second embodiment is the same as the task assignment management system 100 of the first embodiment.

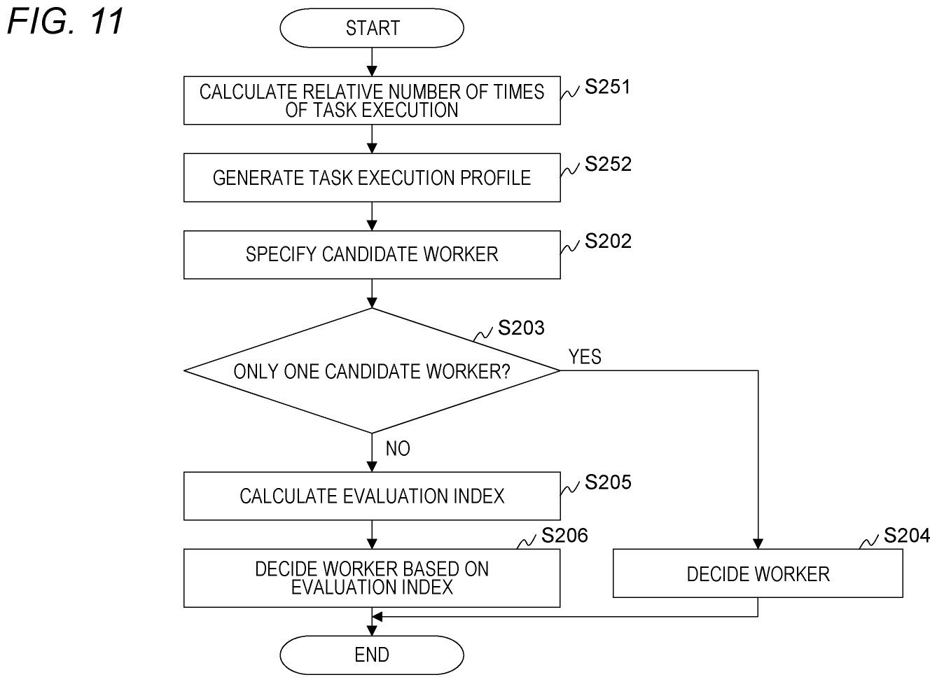

The worker selection processing in the second embodiment partially differs from the worker selection processing in the first embodiment with respect to the processing content. FIG. 11 is a flowchart illustrating one example of a worker selection processing that the task assignment management system 100 of the second embodiment executes.

The task assignment management unit 110 calculates the relative number of times of task execution (step S251). More specifically, the following processing is executed.
(S251-1) The task assignment management unit 110 evaluates the processing capability of each worker with respect to the task based on the task profile 800. For example, the task assignment management unit 110 ranks workers in descending order of the maximum token length 304.
(S251-2) The task assignment management unit 110 calculates the relative number of times of task execution based on the order of the processing capabilities of the workers with respect to the tasks. For example, a method is considered where the task assignment management unit 110 calculates the order of the processing abilities of the workers directly as the relative number of times of task execution.

It is expected that the higher the processing performance, a desired result can be obtained with a smaller number of times of task execution. In view of the above, in the present embodiment, the number of times of task execution is estimated based on the processing performance. In this manner, it is possible to estimate the number of times of task execution of the worker without using the task execution log.
(S251-3) The task assignment management unit 110 stores the workers and the relative numbers of times of task execution in the work area in an associated manner.

The task assignment management unit 110 generates a task execution profile based on the relative number of times of task execution and the task profile 800 (step S252). More specifically, the following processing is executed.
(S252-1) The task assignment management unit 110 selects a worker.
(S252-2) The task assignment management unit 110 copies the task profile 800. Only specific fields such as the token length and the task type may be copied. The task assignment management unit 110 adds a field to the copied task profile 800, and sets the relative number of time of task execution to the field thus generating a task execution profile.

The processing from step S202 to step S204 and the processing in step S206 are the same as the corresponding steps in the first embodiment. The processing in step S205 is partially different from the corresponding processing in the first embodiment with respect to the processing content. More specifically, the number of times of task execution is replaced with the relative number of times of task execution.

The present invention is not limited to the above-described embodiments, and includes various modifications of these embodiments. For example, the above-described embodiments have been described in detail for facilitating the understanding of the present invention. However, it is not always the case that the present invention is limited to the task assigning system that includes all constituent elements described above. Further, with respect to parts of the configurations of the respective embodiments, the addition, the deletion and the replacement of other configurations can be made.

In addition, parts or the entirety of the above-described configurations, functions, processing units, processing means, and the like may be realized by hardware, for example, by designing them using an integrated circuit. In addition, the present invention can also be realized by a program code of software that realizes the functions of the embodiments. In this case, a storage medium in which the program code is recorded is provided to a computer, and a processor that the computer includes reads the program code stored in the storage medium. In this case, the program code itself that is read from the storage medium realizes the functions of the above-described embodiments. Accordingly, the program code itself and the storage medium that stores the program code constitute the present invention. As a storage medium for supplying such a program code, for example, a flexible disk, a CD-ROM, a DVD-ROM, a hard disk, a solid state drive (SSD), an optical disk, a magneto-optical disk, a CD-R, a magnetic tape, a non-volatile memory card, a ROM, or the like is used.

In addition, the program code that realizes the functions described in the present embodiment can be implemented by programs or script languages in a wide range such as an assembler, C/C++, perl, Shell, PHP, Python, Java (registered trademark) and the like.

Furthermore, the functions of the task assignment management system may be executed such that a program code of software that realizes the functions of the embodiment may be distributed via a network, is stored in a storage means such as a hard disk or a memory of a computer or a storage medium such as a CD-RW or a CD-R, and a processor that the computer includes reads and executes the program code stored in the storage means or the storage medium.

In the above-described embodiments, control lines and information lines that are considered necessary for describing the task assignment system are indicated, and it is not always the case that all control lines and all information lines necessary in terms of manufacturing a product are indicated. All configurations may be mutually connected to each other.

What is claimed is:

1. A computer system comprising:
a processor;
a storage device connected to the processor; and
a network interface connected to the processor, wherein
the computer system is connected to a plurality of worker systems in each of which a worker that executes a task using a computer resource is operated,
the computer system holds worker management information for managing the worker,
data that is constituted of items indicating identification information of the worker and characteristics of the worker is stored in the worker management information, and
in at least one of the worker systems, a large-scale language model that executes a language processing task where a prompt that is a text describing an instruction content is received and a text which forms a response is outputted is operated as the worker, and
the processor is configured:
to receive a task execution request;
to generate, for each of the workers, task execution information relating to a plurality of tasks to be executed until a desired result is obtained;
to identify candidate workers based on the worker management information and the task execution information, and
to select the worker to which the task is assigned from the candidate workers.

2. The computer system according to claim 1, wherein
the items indicating the characteristics of the worker include at least a cost associated with execution of the task, and
the processor is further configured:
to calculate the number of times of task execution until a desired result is obtained with respect to the candidate workers;
to calculate evaluation indexes of the candidate workers based on the cost and the number of times of task execution; and
to select the worker to which the task is assigned from the candidate workers based on the evaluation indexes.

3. The computer system according to claim 2, wherein
the task execution request includes a condition relating to a characteristic of the worker to be used, and
the processor identifies the candidate worker that satisfies the condition included in the task execution request by referencing the worker management information and the task execution information.

4. The computer system according to claim 3, wherein
in a case where the processor receives an execution request of a new task after the worker is selected, the processor is configured to assign the task to the selected worker.

5. The computer system according to claim 3, wherein
the computer system is configured to hold execution log information that stores an execution log of the task executed by the worker;
in the execution log information, the execution logs of a plurality of tasks that are executed until a desired result is obtained are managed in an associated manner with each other, and
the processor generates the task execution information for the respective workers by referencing the execution log information.

6. The computer system according to claim 5, wherein
in the plurality of tasks that are executed until the predetermined result is obtained, the execution log of the task that is executed last contains a user evaluation with respect to the worker to which the task is assigned,
the processor is configured to correct the evaluation index based on the user evaluation.

7. The computer system according to claim 3, wherein
the processor is configured:
to decide an order of processing performance of the respective workers with respect to the task that is requested to be executed by referencing the worker management information,
to calculate the number of times of task execution by executing an arithmetic operation using the order.

8. The computer system according to claim 3, wherein
the task execution request includes, as the condition, at least one of a size of data in the task, presence or non-presence of use of external data in the worker, a type of the external data, and processing performance of the worker.

9. A task assignment control method that a computer system is configured to execute, wherein
the computer system includes:
a processor;
a storage device connected to the processor; and
a network interface connected to the processor, wherein
the computer system is connected to a plurality of worker systems in each of which a worker that executes a task using a computer resource is operated,
the computer system holds worker management information for managing the worker,
data that is constituted of items indicating identification information of the workers and characteristics of the workers is stored in the worker management information, and
in at least one of the worker systems, a large-scale language model that executes a language processing task where a prompt that is a text describing an instruction content is received and a text which forms a response is outputted is operated as the worker,
the task assignment control method comprising:
a first step of receiving a task execution request by the processor;
a second step of generating task execution information relating to a plurality of tasks that are executed until a desired result is obtained with respect to the respective workers by the processor;
a third step of identifying candidate workers based on the worker management information and the task execution information by the processor; and
a fourth step of selecting the worker to which the task is assigned out of the candidate workers by the processor.

10. The task assignment control method according to claim 9, wherein
the items indicating characteristics of the workers include at least a cost associated with execution of the task,
the second step includes calculating a number of times of task execution until a desired result is obtained with respect to the respective workers by the processor, and
the fourth step includes:
a fifth step of calculating an evaluation index of the candidate worker based on the cost and the number of times of task execution by the processor; and
a sixth step of selecting the worker to which the task is assigned out of the candidate workers based on the evaluation index by the processor.

11. The task assignment control method according to claim 10, wherein
the task execution request includes a condition relating to a characteristics of the worker that is used: and
the third step includes identifying, by the processor, the candidate worker which satisfies the condition contained in the task execution request by referencing the worker management information and the task execution information.

12. The task assignment control method according to claim 11, wherein
the computer system holds execution log information that stores an execution log of the task that the worker executes,
in the execution log information, the execution logs of the plurality of tasks which are executed until a desired result is obtained are managed in an associated manner with each other, and
the second step includes generating the task execution information by referencing the execution log information by the processor.

13. The task assignment control method according to claim 12, wherein
in the plurality of tasks that are executed until the desired result is obtained, the execution log of the task that is executed last includes a user evaluation with respect to the worker to which the task is assigned; and
the fifth step includes correcting the evaluation index based on the user evaluation by the processor.

14. The task assignment control method according to claim 11, wherein
the second step includes:
deciding an order of processing performance of the respective workers with respect to the tasks that are requested to be executed by referencing the worker management information by the processor; and
calculating a number of times of task execution by executing an arithmetic operation using the order by the processor.

15. The task assignment control method according to claim 11, wherein
the task execution request includes, as the condition, at least one of a size of data in the task, presence or non-presence of use of external data in the worker, a type of the external data; and processing performance of the worker.
